(19) United States
(12) Patent Application Publication
(10) Pub. No.: US 2026/0121031 A1
(43) Pub. Date: Apr. 30, 2026

(54) LITHIUM ION BATTERY ANODE AND METHOD TO MAKE THEM

(71) Applicant: Wildcat Discovery Technologies, Inc., San Diego, CA (US)

(72) Inventors: Jinhua Huang, San Diego, CA (US); Ye Zhu, San Diego, CA (US); Gang Cheng, San Diego, CA (US); Bin Li, San Diego, CA (US); Peter Bennington, San Diego, CA (US)

(21) Appl. No.: 19/480,182

(22) PCT Filed: May 3, 2024
(86) PCT No.: PCT/US2024/027650

§ 371 Date: Oct. 30, 2025

Related U.S. Application Data
(60) Provisional application No. 63/464,374, filed on May 5, 2023.

(51) Int. Cl. H01M 4/36; H01M 4/02; H01M 4/134; H01M 10/0525; H01M 10/0567; H01M 10/0568; H01M 10/0569

(52) U.S. Cl. CPC H01M 4/366; H01M 4/134; H01M 10/0525; H01M 10/0567; H01M 10/0568; H01M 10/0569; H01M 2004/027

(57) ABSTRACT

Anodes having a laminate comprised of a lithium metal having adhered thereto a layer comprised of a thermoset polymer may be formed by contacting a lithium foil with an addition monomer to form an uncured layer and polymerizing the addition monomer forming a layer of a thermoset polymer adhered to the lithium metal foil or by contacting a metal foil other than lithium with an addition monomer to form an uncured layer, polymerizing the addition monomer forming a layer of a thermoset polymer adhered to the metal foil to form a lithium free metal anode and electrochemically introducing lithium ions to the lithium free metal anode to form the lithium metal laminate anode.

### FIELD

This disclosure is directed to lithium ion batteries having an anode comprised of lithium metal and in particular laminate metal anodes.

### BACKGROUND

Conventional lithium ion batteries include a positive electrode (cathode), a negative electrode (anode), an electrolyte, and typically a separator. The anode in many lithium ion batteries is carbon-based, such as graphite. However, a lithium metal anode can provide several advantages over graphite and other carbon-based anode materials. Lithium metal has very high theoretical specific capacity (3860 mA h g-1), low density (0.59 g cm-3) and very low negative electrochemical (e.g., redox) potential (−3.040 V vs. the standard hydrogen electrode). These attributes could enable rechargeable lithium metal batteries to significantly increase the cell-level energy of state-of-the-art lithium ion batteries.

Lithium metal, however, has several drawbacks that have limited the commercialization of lithium metal batteries. The drawbacks may include high reactivity of lithium metal anode, formation of an unstable solid electrolyte interphase (SEI), growth of lithium dendrites, evolution of inactive lithium during lithium plating and stripping, and/or volume change during battery operation. The dendrites can penetrate the battery separator, resulting in short circuiting of the battery and volatilization of the liquid electrolyte due to increased temperature. Due to these issues, experimentally-tested lithium metal batteries have been observed to have low columbic efficiency (CE), relatively short battery life, safety concerns, and sluggish electrode kinetics.

Accordingly, it would be desirable to provide an anode comprised of lithium metal that avoids one or more of problems associated with lithium metal batteries.

### SUMMARY

Applicant has discovered that lithium ion batteries (LIBs) having lithium metal anodes may have improved safety, longer cycle life, faster electrode kinetics, higher coulombic by use of a laminated lithium metal anode in an LIB having a liquid electrolyte. The laminated lithium metal anodes is comprised of a lithium metal foil having a layer adhered thereto, the layer being comprised of a thermoset polymer and a lithium salt. Thermoset polymer is used herein to refer to any cross-linked polymer that may be cured/cross-linked by any suitable method such as those known in the art. It has been discovered that improved cycle life while maintaining other desirable attributes may be realized when using such a laminated lithium metal anode in an LIB, where the localized electrochemical environment may be controlled, which may allow for desired ionic conductivity associated with the thermoset polymer, solid electrolyte formation, lithium dendrite suppression.

An illustration is an anode, comprising a laminate comprised of a lithium metal having adhered thereto a layer comprised of a thermoset polymer. The layer is sufficiently adhered when it does not dissolve or swell in the liquid electrolyte of a lithium metal battery to cause the layer to become detached within the battery. The anode may be made by method comprising contacting a lithium foil with an addition monomer to form an uncured layer and polymerizing the monomer of the uncured layer forming a layer of a thermoset polymer adhered to the lithium metal foil. The addition monomer typically is comprised of polar groups and an average addition reactive functionality of at least 2 to realize the desired adherence and anode characteristics. Average addition reactive functionality is the number of addition reaction groups divided by the number of addition monomers present in the uncured layer. The anode may be employed in a battery such as a lithium metal battery.

### BRIEF DESCRIPTION OF THE DRAWING

FIG. 1 shows the discharge capacity and capacity retention of batteries of this invention.

FIG. 2 shows the discharge capacity and capacity retention of batteries of this invention and a battery not of this invention.

FIG. 3 shows reproducibility of the discharge capacity and capacity retention of a battery of this invention.

### DETAILED DESCRIPTION

The following definitions apply to some of the aspects described with respect to some embodiments of the invention. These definitions may likewise be expanded upon herein. Each term is further explained and exemplified throughout the description, figures, and examples. Any interpretation of the terms in this description should take into account the full description, figures, and examples presented herein.

Definitions of specific functional groups and chemical terms are described in more detail below. For purposes of this disclosure, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito, 1999; Smith and March March's Advanced Organic Chemistry, 5^{th} Edition, John Wiley & Sons, Inc., New York, 2001; Larock, Comprehensive Organic Transformations, VCH Publishers, Inc., New York, 1989; Carruthers, Some Modern Methods of Organic Synthesis, 3^{rd} Edition, Cambridge University Press, Cambridge, 1987; the entire contents of each of which are incorporated herein by reference.

The terms “halo” and “halogen” as used herein refer to an atom selected from fluorine (fluoro, —F), chlorine (chloro, —Cl), bromine (bromo, —Br), and iodine (iodo, —I). The term “aliphatic group”, as used herein, denotes a hydrocarbon moiety that may be straight-chain (i.e., unbranched), branched, or cyclic (including fused, bridging, and spiro-fused polycyclic) and may be completely saturated or may contain one or more units of unsaturation, but which is not aromatic. Aliphatic groups may contain 1-40 carbon atoms, 1-20 carbon atoms, 2-20 carbon atoms, 1-12 carbon atoms, 1-8 carbon atoms, 1-6 carbon atoms, 1-5 carbon atoms, 1-4 carbon atoms, 1-3 carbon atoms, or 1 or 2 carbon atoms. Exemplary aliphatic groups include, but are not limited to, linear or branched, alkyl and alkenyl groups, and hybrids thereof such as (cycloalkyl)alkyl, (cycloalkenyl)alkyl or (cycloalkyl)alkenyl. The aliphatic groups may be unsubstituted or substituted. Substituted means that one or more C or H atoms is replaced with oxygen, boron, sulfur, nitrogen, phosphorus or halogen. Typically, one to six carbon atoms may be independently replaced by the aforementioned and in particular oxygen, sulfur or nitrogen. The aliphatic group may have one or more “halo” and “halogen” atoms selected from fluorine (fluoro, —F), chlorine (chloro, —Cl), bromine (bromo, —Br), and iodine (iodo, —I).

The anode comprises a laminate of lithium metal adhered to a layer comprised of a thermoset polymer. The lithium metal may be lithium metal foil roll pressed to the desired thickness. The lithium metal may be coated (e.g., sputtered) upon a current carrier in the battery, which may be another metal such as copper. The lithium metal includes lithium metal alloys. The lithium metal may be treated to improve a characteristic such as adherence and may include roll pressing a lithium metal foil, immersion (reacted to form a solid electrolyte interface layer at the lithium metal surface) or combination thereof (see, for example, ACS Appl. Mater. Interfaces 2021, 13, 34227-34237). The lithium metal layer maybe any useful thickness. Illustratively, the thickness may be from 1 micrometer, 5 micrometers, 10 micrometers, 20 micrometers, or 50 micrometers to 100, 200, 350 or 500 micrometers. In another illustration, the thermoset polymer may be directly adhered to a metal current collector (e.g., copper) and subsequently during formation of the battery, lithium may be deposited on the current collector through the polymer layer.

The layer is comprised of a thermoset polymer having sufficient cross-linking to ensure the adherence of the layer in the liquid electrolyte of the lithium metal battery (LMB). To form the thermoset layer, generally, the addition monomer comprises one or more monomer having one or more polar groups useful to be solvated by the liquid electrolyte used in the formation of the LMB and a sufficient number of polymerizable alkenes or alkynes (e.g., 2, 3 to 5 or 6) to realize the desired adherence and characteristics. Useful addition monomers include vinyl, allyl monomers having one or more of a carbonyl, ether, amide, imide, sulfonyl group. Examples of addition polymerizable monomers may include (meth)acrylates, conjugated dienes, vinylidene substituted aromatic monomers, vinylidene halides, vinyl acetates, unsaturated nitriles, cyanoacrylates, maleates, fumarates, maleimides and itaconates.

As an illustration the addition monomer may be an acrylate, in which at least a portion has two or more addition polymerizable C═C groups. The acrylate may be represented by:

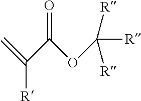

wherein R′ is hydrogen or an aliphatic group having 1 to 4 carbons and each R″ is a substituted or unsubstituted cyclic, linear, branched, or aromatic hydrocarbyl group having 1 to 24 carbons. Desirably, at least one R″ is an alkenyl or alkynyl group substituted with one or more of O, S, N, and halogen such as present in an ether, carbonyl, amide, imide or sulfonyl group. The one or more of R″ may be terminated with an acrylate group (H₂C═CHCO₂) interconnected by a short chain ether (e.g., (CH₂CH₂O)ₙ where n is from 1 to 6 or a linear aliphatic chain of 1 to 8 carbons. Desirably, R′ is hydrogen or methyl and at least one, two or all of R″ is an acrylate having an interconnecting aliphatic chain of 1 to 4 carbons. Exemplary multifunctional acrylates, allyl or vinyl monomers may include pentaerythritol tetracrylate (PETEA), trimethylolpropane trimethacrylate, trimethylolpropane propolylate triacrylate, vinyl methacrylate, bisphenol A glycerolate dimethacrylate. bisphenol A ethoxylate dimethacrylate (n=15), Bisphenol A Ethoxylate Dimethacrylate (n=4), dipentaerythritol penta-/hexa-acrylate, dipentaerythritol penta-/hexa-acrylate, di(trimethylolpropane) tetraacrylate, divinyltetramethyldisiloxane, ethylene glycol dimethacrylate, 1,6-hexanediol dimethacrylate, neopentyl glycol dimethacrylate, bis[2-(methacryloyloxy)ethyl]phosphate, phosphoric acid 2-hydroxyethyl methacrylate ester, polyethylene glycol dimethacrylate, n=14, pentaerythritol tetraacrylate, poly(propylene glycol)diacrylate, n=12, poly(propylene glycol)dimethacrylate, n=7, diurethane dimethacrylate, triallyl cyanurate, 1,3,5-Triallyl-1,3,5-triazine-2,4,6(1H,3H,5H)-trione, triallylphosphate, triallylphosphite, glycerol 1,3-diglycerolate diacrylate, 3-(trimethoxysilyl)propyl methacrylate, triethylene glycol dimethacrylate, trimethylolpropane ethoxylate triacrylate, Trimethylolpropane ethoxylate triacrylate (n=5), trimethylolpropane triacrylate, trimethylolpropane trimethacrylate, tetravinylsilane, and bisphenol A dimethacrylate.

Monofunctional monomer such as an acrylate may include, for example, 2,2,3,3-tetrafluropropyl methacrylate, methyl acrylate, ethyl acrylate, n-propyl acrylate, n-butyl acrylate, 2-ethylhexyl acrylate, and alkyl methacrylates, such as hexyl methacrylate, 2-ethylhexyl methacrylate, n-lauryl methacrylate, n-butyl acrylate in combination with a multifunctional addition monomer.

To ensure adequate adherence, ionic conductance, adequate wetting by the solvents of the liquid electrolyte and formation of a desirable solid-electrolyte interface, the addition monomers generally have an average addition reactive functionality of at least about 1.5, 2, 2.5 or 3 to 6 or 5. It may also be desirable that each of the addition monomers present in the layer has 2 or 3 to 5 or 6 addition reactive groups (i.e., no unifunctional monomers are present other than those that may be present due to incomplete reactions when forming the monomers, with less than 1% or 0.1% by mole of monomers present being monofunctional). Alternatively, it may be desirable to mix addition monomers that are monofunctional with higher multifunctional monomers to realize the desired average addition reactive functionality.

The layer inevitably is comprised of a lithium salt when the anode is exposed to the salt within the solvents of the liquid electrolyte in a battery. It, however, may be desirable to have the salt present in the uncured layer when forming the layer adhered to the lithium metal. The uncured and subsequently the layer adhered to the lithium metal may have any useful amount of lithium salt such as 1%, 2%, 5%, 10% to 40%, 35%, 30% or 25% by volume or weight of the uncured or the layer (after polymerizing) adhered to the lithium metal. The salt may be the chemically the same or different than the salt present in the liquid electrolyte used in the battery.

The polymerization of the addition monomer may be performed using any known method such as applying heat, electromagnetic radiation, the addition of an initiator/catalyst or any combination thereof. Exemplary initiators may include latent initiators that may be activated upon heating or exposure to electromagnetic radiation. For example, the initiator may be comprised of one or more a photolatent base, which is a compound that upon exposure to radiation or heat releases a base such as an amine, guanidine or amidine that is capable initiating anionic polymerization. The photolatent base may also upon exposure to radiation may generate free radicals which initiate free radical polymerization. Any compound that forms or releases an amine which initiates anionic polymerization upon exposure to radiation may be used. The photolatent bases may absorb light and photocleave in a wavelength range from about 200 nm to about 650 nm. Any compound that forms or releases an amine which initiates anionic polymerization and form free radicals to initiate free radical polymerization upon exposure to radiation may be used. The photolatent basephotolatent bases may release alkyl amines, compounds with amidine structures or guanidines. The photolatent bases may release alkyl amines. The alkyl amines may be monoalkyl amines, primary amines, dialkyl amines, secondary amines or trialkyl amines, tertiary amines. Photolatent bases include photocleavable carbamates (e.g., 9-xanthenylmethyl, fluorenylmethyl, 4-methoxyphenacyl, 2,5-dimethylphenacyl, benzyl, and others), which have been shown to generate primary or secondary amines after photochemical cleavage. Other photolatent bases which generate primary or secondary amines include certain O-acyloximes, sulfonamides, and formamides. Acetophenones, benzophenones, and acetonaphthones bearing quaternary ammonium undergo photocleavage to generate tertiary amines in the presence of a variety of counter cations (borates, dithiocarbamates, and thiocyanates). Examples of these photolatent ammonium salts are N-(benzophenonemethyl)tri-N-alkyl ammonium tetraphenylborates. Sterically hindered α-aminoketones generate tertiary amines. Exemplary photolatent bases useful for practicing the present disclosure include 5-benzyl-1,5-diazabicyclo[4.3.0]nonane, 5-(anthracen-9-yl-methyl)-1,5-diaza[4.3.0]nonane, 5-(2′-nitrobenzyl)-1,5-diazabicyclo[4.3.0]nonane, 5-(4′-cyanobenzyl)-1,5-diazabicyclo[4.3.0]nonane, 5-(3′-cyanobenzyl)-1,5-diazabicyclo[4.3.0]nonane, 5-(anthraquinon-2-yl-methyl)-1,5-diaza[4.3.0]nonane, 5-(2′-chlorobenzyl)-1,5-diazabicyclo[4.3.0]nonane, 5-(4′-methylbenzyl)-1,5-diazabicyclo[4.3.0]nonane, 5-(2′,4′,6′-trimethylbenzyl)-1,5-diazabicyclo[4.3.0]nonane, 5-(4′-ethenylbenzyl)-1,5-diazabicyclo[4.3.0]nonane, 5-(3′-trimethylbenzyl)-1,5-diazabicyclo[4.3.0]nonane, 5-(2′,3′-dichlorobenzyl)-1,5-diazabicyclo[4.3.0]nonane, 5-(naphth-2-yl-methyl-1,5-diazabicyclo[4.3.0]nonane, 1,4-bis(1,5-diazabicyclo[4.3.0]nonanylmethyl)benzene, 8-benzyl-1,8-diazabicyclo[5.4.0]undecane, 8-benzyl-6-methyl-1,8-diazabicyclo[5.4.0]undecane, 9-benzyl-1,9-diazabicyclo[6.4.0]dodecane, 10-benzyl-8-methyl-1,10-diazabicyclo[7.4.0]tridecane, 11-benzyl-1,11-diazabicyclo[8.4.0]tetradecane, 8-(2′-chlorobenzyl)-1,8-diazabicyclo[5.4.0]undecane, 8-(2′,6′-dichlorobenzyl)-1,8-diazabicyclo[5.4.0]undecane, 4-(diazabicyclo[4.3.0]nonanylmethyl)-1,1′-biphenyl, 4,4′-bis(diazabicyclo[4.3.0]nonanylmethyl)-11′-biphenyl, 5-benzyl-2-methyl-1,5-diazabicyclo[4.3.0]nonane, 5-benzyl-7-methyl-1,5,7-triazabicyclo[4.4.0]decane, and combinations thereof. An example of a photolatent base is available from BASF under the trade designation “CGI-90”, which is reported to be 5-benzyl-1,5-diazabicyclo[4.3.0]nonane (see, e.g., WO 2014/176490 (Knapp et al.)), which generates 1,5-diazabicyclo[4.3.0]non-5-ene (DBN) upon exposure to radiation (see, e.g., US2013/0345389 (Cai et al), 2-benzyl-1-(3,5-dimethoxyphenyl)-2-(dimethylamino)butan-1-one available from BASF under the trade designation CGI 277, p-(Ethylthio)phenyl methylcarbamate and 6-Nitroveratryl chloroformate diethyl amine.

The initiator may be radical initiator such as those known in the art and may include a radical photoinitiator. Illustratively, radical initiators such as photoinitiators are well known and are, for example, described in the art such as in “Mechanisms of Photophysical Processes and Photochemical Reactions in Polymers' by J. F. Rabek, pp. 228-337 (1987). Illustrative examples of photoinitiators include the aromatic ketones such as acetophenone, 1-hydroxy-cyclohexyl-phenyl-ketone chlorinated acetophenone, dialkoxyacetophenones, dialkylhydroxyacetophenones, dialkylhydroxyacetophenone alkyl ethers, 1-benzoylcyclohexanol-2, benzoin, benzoin acetate, benzoin alkyl ethers, dimethoxybenzoin, deoxybenzoin, dibenzyl ketone, acyloxime esters, acylphosphine oxides, acylphosphonates, ketosulphides, dibenzoyl disulphides, and diphenyldithiocarbonate. The initiator may include azo and peroxide initiators such as available from Fujifilm Wako Chemicals USA Corp. (Richmond, VA). Exemplary azo initiators may include 1,1′-Azobis(cyclohexane-1-carbonitrile), 4,4′-Azobis(4-cyanovaleric acid), Dimethyl 2,2′-azobis(2-methylpropionate), 2,2′-Azobis[2-methyl-N-(2-hydroxyethyl)propionamide], 2,2′-Azobis (N-butyl-2-methylpropionamide), 2,2′-Azobis[2-(2-imidazolin-2-yl)propane]dihydrochloride, 2,2′-Azobis[2-(2-imidazolin-2-yl)propane], 2,2′-Azobis(2-methylpropionamidine)dihydrochloride, 2,2′-Azobis[N-(2-carboxyethyl)-2-methylpropionamidine]tetrahydrate, and 2,2′-Azobis(isobutyronitrile).

Mixtures of initiators may be used. The amount of initiator may be any useful amount and typically is from 0.01%, 0.1%, 0.5% to 20%, 15%, 10% or 5% by weight of the addition monomers and initiators.

The salt may be any useful to make a battery. Desirably the salt is comprised of a lithium salt. Exemplary lithium salts may include one or more of (oxalato)borate (LiBOB), lithium bis(pentafluoroethylsulfonyl)imide (Li-BETI), lithium bis(fluorosulfonyl)imide (LiFSI), lithium tetrafluoroborate (LiBF₄), lithium trifluoromethanesulfonate (LiTriflate), lithium hexafluoroarsenate (LiAsF₆), lithium bis(trifluoromethanesulfonimide) (LiTFSI), and lithium hexafluoro-phosphate (LiPF₆), lithium nitrate (LiNO₃), LiN(SO₂CF₃)₂, LiN(SO₂F)₂, LiCF₃SO₃, LiClO₄, lithium difluoro oxalato borate anion (LiDFOB), LiI, LiBr, LiCl, LiOH, LiSO₄, any combination thereof.

Further illustrations of salts include that may be useful include alkali metal salt, an alkaline earth metal salt, or any combination thereof. For example, the lithium salt may include a sodium salt, a magnesium salt, a mixture of lithium and sodium salts, a mixture of lithium and magnesium salts, a mixture of lithium, magnesium, and sodium salts, a mixture of sodium and magnesium salts, or any combination thereof. For example, the lithium salt may include one or more of sodium bis(fluorosulfonyl)imide (NaFSI), sodium bis(trifluoromethylsulfonyl)imide (NaTFSI), sodium bis(oxalato)borate (NaBOB), NaFSI, NaTFSI, any lithium salt, or any combination thereof.

The thickness of the layer may be any useful, but generally is less than the thickness of the metal to realize the greatest battery energy capacity while realizing the desired performance of the LIB. Generally, the thickness is at least 0.05 micrometer, 0.1 micrometer, 0.25 micrometer, 0.5 micrometer, 1 micrometer, 2, micrometer, 5 micrometers, or 10 micrometers to 200 micrometers, 150 micrometers or 100 micrometers. Generally, such thickness correlate with the layer being from about 0.1%, 0.2%, 0.5%, 1% to 10% or 5% by weight of the layer and the lithium metal.

The adequacy of the adherence of the layer for any particular LIB having a liquid electrolyte may be determined by soaking the anode in the liquid electrolyte for at least 24 hours at room temperature (˜25° C.) and no separation from the lithium metal of the layer is observed. Desirably, the layer has some swelling within the liquid electrolyte used in the battery. Illustratively, the swelling may from 1%, 2%, 5%, to 200%, 150%, 100%, 75% or 50%, 25%, 20% or 10% as determined after soaking a layer (i.e., not deposited on lithium metal but made in the same manner on a substrate in which the layer does not adhere as well such as a low surface energy sheet/film such a TEFLON or copper) in the liquid electrolyte for 24 hours. The swelling may be determined dimensionally before and after soaking or by the mass of the film prior to exposure to the electrolyte and the amount of electrolyte retained after being exposed to the electrolyte after removing excess electrolyte mechanically (e.g., pipette).

The layer may be uniform chemically (e.g., same addition polymer) or characteristically (e.g., differing property such as swelling) across its thickness (from its contact with the lithium metal surface to its outer surface orthogonally projecting from the lithium metal surface). The layer may be non-uniform such as having sub-layers formed using differing monomers or ratio of monomers (e.g., differing average functionality) that may be formed by successive different sublayers.

The layer may be further comprised of an additive such as a plasticizer or inorganic particulate. The amount of additives may any useful amount, but typically, they are present in an amount of 0.1% to 10% or 5% by volume or weight of the layer. Illustratively, the additive may be a particulate capable of intercalating lithium such as those known in the art. For example, the intercalating particulate may be a graphitic material capable of intercalating lithium. Illustrative graphitic material may be a spherical graphite of an artificial graphite or purified natural graphite. Examples of useful spherical graphites are described in U.S. Pat. Pub. 2016/0141603 and U.S. Pat. No. 9,276,257, each incorporated herein by reference. Examples of suitable commercially available spherical graphites include those available from Syrah Resources, Magnis Resources, Northern Graphite, Focus Graphite and Graphite One. The lithium intercalating particulate may also be silicon, its alloys, or lithium titanate. Other additives such as fillers that impart a desired mechanical characteristic may also be added.

The anode is useful to make a LIB having a liquid electrolyte. The liquid electrolyte of the LIB is comprised of a polar aprotic solvent and a dissolved salt. The salt may be any of those described above. The solvent may be any useful to make a liquid electrolyte for a LIB with mixtures of solvents being desirable. The solvents may solubilize the salts in the battery in different degrees including forming localized high salt concentration electrolytes such as described by U.S. Pat. Nos. 10,367,232 and 11,094,966. Exemplary solvents may include dialkoxy alkanes, dialkyl glycol ethers, disubstituted esters, disubstituted carbonates, trisubstituted phosphates, disubstituted sulfones, tetrasubstituted silanes, or any combination thereof.

Desirably, the battery is comprised of a liquid electrolyte having at least one salt that is chemically different that the lithium salt present in the layer when formed and in some instances each of the salts dissolved in the liquid electrolyte is different than the salt in the layer when formed. It may also be desirable for the liquid electrolyte to be comprised of at least two polar aprotic solvents. When the liquid electrolyte is comprised of two or more solvents, desirably at least one of the solvents is preferentially absorbed (causes greater swelling by at least 10% or 20% to 50% of the layer, which may be constrained or unconstrained) than the other solvent(s) in the liquid electrolyte. The swelling of the layer may be any amount, but desirably is less than 100%, 75%, 50%, 25% by volume/weight in the liquid electrolyte.

The concentration of salt in the liquid electrolyte may be any useful amount and typically is present in the electrolyte at a concentration of 0.1 M, 0.5 M, or 1.0 M to 1.5 M, 2, M, 3.5 M or the saturation point of the salt in the liquid electrolyte at the operating conditions of the battery.

Dialkoxy alkanes may include a pair of alkyl ethers bound by a C₁₋₁₂ alkane group that may be branched or linear. For example, dialkoxy alkanes may include one or more of dimethoxy ethane (DME), diethoxy ethane (DEE), 1,2-dimethoxypropane (DMP), The dialkoxy alkane may have the following structure:

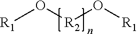

where each R₁ may independently comprise a C₁₋₁₂ alkyl group that may be linear or branched, or any combination thereof.
where R₂ may comprise a C₁₋₁₂ alkyl group that may be linear or branched, or any combination thereof.
where n is an integer between 1 and 5.

Dialkyl glycol ethers may include a series of three either groups separated by alkyl chains that may be linear or branched. Example of dialkyl glycol eithers may include one or more of 1,2-diethylene glycol isopropyl methyl ether (DEGIM), diethylene glycol butyl methyl ether (DEGBM), or any combination thereof. The dialkyl glycol may have the following structure:

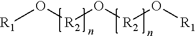

where each R₁ may independently comprise a C₁₋₁₂ alkyl group that may be linear or branched, or any combination thereof.
where each R₂ may independently comprise a C₁₋₁₂ alkyl group that may be linear or branched, or any combination thereof.
where each n is an integer between 1 and 5.

Disubstituted esters may include an ester that is substituted at the carbon atom of the carbonyl or the oxygen atom of the hydroxyl group by one or more groups including hydrogen, C₁₋₁₂ alkyl, C₁₋₁₂ aryl, or any combination thereof. Examples of disubstituted esters may include one or more of ethyl difluoroacetate, ethyl propionate, or any combination thereof. The disubstituted ester may have the following structure:

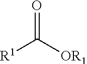

where each R₁ may independently comprise a hydrogen atom, a C₁₋₁₂ alkyl group that may be linear or branched, a hetero-alkyl group that may be linear or branched, or any combination thereof. Both R₁ in combination may form a cyclic alkyl ring that may optionally include one or more hetero atoms.

Disubstituted carbonates may be substituted independently at each of the carbon atoms. Disubstituted carbonates may include dimethyl carbonate, diethyl carbonate, ethyl methyl carbonate, fluoroethylene carbonate, or any combination thereof. The disubstituted carbonate may have the following structure:

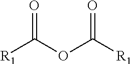

where each R₁ may independently comprise a hydrogen atom, a C₁₋₁₂ alkyl group that may be linear or branched, a hetero-alkyl group that may be linear or branched, or any combination thereof. Both R₁ in combination may form a cyclic alkyl ring that may optionally include one or more hetero atoms.

Trisubstituted phosphates may be substituted at each of the single bonded oxygen atoms. Trisubstituted phosphates may include trimethyl phosphate, triethyl phosphate, or any combination thereof. The trisubstituted phosphates may have the following structure:

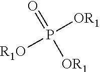

where each R₁ may independently comprise a hydrogen atom, a C₁₋₁₂ alkyl group that may be linear or branched, a hetero atom, a hetero-alkyl group, or any combination thereof.
where each R₂ may independently comprise a hydrogen atom, C₁₋₁₂ alkyl group that may be linear or branched, or any combination thereof.

Disubstituted sulfones may be substituted at the sulfur atom by one or more groups including hydrogen, C₁₋₁₂ alkyl, C₁₋₁₂ aryl, or any combination thereof. Disubstituted sulfones may include sulfolane, methyl ethyl sulfone, methyl isopropyl sulfone, or any combination thereof. The disubstituted sulfones may have the following structure:

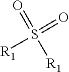

where each R₁ may independently comprise a hydrogen atom, a C₁₋₁₂ alkyl group that may be linear or branched, a hetero-alkyl group that may be linear or branched, or any combination thereof. Both R₁ in combination may form a cyclic alkyl ring that may optionally include one or more hetero atoms.

Tetrasubstituted silanes may be substituted at the silicon atom and/or each oxygen atom. Tetrasubstituted silanes may include triethyoxymethyl silane, trimethoxymethylsilane, or any combination thereof. The tetrasubstituted silanes may have the following structure:

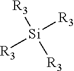

where each R₃ may independently comprise a hydrogen atom, a C₁₋₁₂ alkyl group that may be linear or branched, a hetero atom, a hetero-alkyl group, C₁₋₁₂ alkoxy group that may be linear or branched, a hetero atom, a hetero-alkyl group, or any combination thereof.

Examples of solvents may include a fluorinated ethers such as 1,1,2,2-tetrafluoroethyl 2,2,3,3-tetrafluoropropyl ether (TTE); bis(2,2,2-trifluoroethyl) ether (BTFE), hexafluoroisopropyl methyl ether (HFPME); 1,1,2,2-tetrafluoroethyl ethyl ether (TFEEE); 1H,1H,5H-octafluoropentyl 1,1,2,2,-tetrafluoroethyl ether (OFPTFEE); 1,1,2,2-tetrafluoroethyl ether, 1,2-(1,1,2,2,-tetrafluoroethoxy) ethane (TFEE); 1,3-(1,1,2,2-Tetrafluoroethoxy)propane (TFEP), 1,1,2,3,3,3-hexafluoro propyl 2,2,2-trifluoroethyl ether (HFPTFEE); n-butyl 1,1,2,2-tetrafluoroethyl ether (BTFEE); 1H,1H,2′H,3H-decafluoro dipropyl ether (DFDPE); 1,1,2,3,3,3-hexafluoropropyl ethyl ether (HFPEE); 1,1,1-trifluoro-2-[1-(2,2,2-trifluoroethoxy)ethoxy]ethane (TTFEEE); 1H,1H,2′H-perfluorodipropyl ether (PFDPE); 1,1,2,2-tetrafluoroethyl isobutyl ether (TFEBE); 1,1,1,2,2,3,4,5,5,5-decafluro-2-methoxy-4-(trifluoromethyl)pentane; 1-(ethoxy)nonafluorobutane having a mixture of n- and iso-butyl isomers; 2-(trifluoromethyl)-3-ethoxydodecafluorohexane; 3-methoxyperfluoro(2-methylpentane); heptafluoropropyl 1,2,2,2-tetrafluoroethyl ether; 1,1,2,2-tetrafluoroethyl-2,2,2-trifluoroethyl ether (TFTFE); methoxynonafluorobutane (MOFB); ethoxynonafluorobutane (EOFB); tris(2,2,2-trifluroethyl)orthoformate; di(2,2,2-trifluroethyl) carbonate; or any combination thereof.

In an illustration the electrolyte comprises a low boiling point solvent and a high boiling point solvent and a salt. The high boiling point solvent is a solvent that has a boiling point of at least 140° C., but desirably is at least 160° C., 180° C. or 200° C. to any practical temperature, but typically at most about 350° C. or 300° C. The low boiling point solvent is a solvent that has a boiling point that is less than 140° C., but typically is at most 130° C., 120° C. or even 110° C. to any practical temperature such as at least 70° C., 90° C. or 100° C. Solvent herein is any low molecular weight (typically at most 300 gram/moles, 250 gram/moles or 200 gram/moles) solvent such as a polar aprotic solvent that is useful in dissolving the salt. Generally, the aprotic polar solvents have essentially no water (e.g., less than 100 ppm, 50 ppm or 20 ppm of water by weight).

Generally, the high boiling point solvent is an aprotic polar solvent having a high dielectric constant (e.g., dielectric constants greater than 20, 40, 60 or 80). Examples of such solvents include cyclic aprotic polar solvents having one or more substituted atoms such as O, N, S, and halogen (e.g., F). The dielectric constant may be calculated from the dipoles present in the solvent molecule or determined experimentally such as described in J. Phys. Chem. C 2017, 121, 2, 1025-1031.

Generally, the low boiling point solvents are aprotic polar solvents having a low dielectric constant (e.g., at most about 20, 15 or 10). Examples of such solvents include linear or branched aprotic polar solvents having one or more substituted atoms of O, N, S, and halogen (e.g., F). Examples of such solvents include linear carbonates (e.g., ethylmethyl carbonate (EMC), dimethyl carbonate (DMC), diethyl carbonate (DEC)), as well as certain ethers (such as 1,2-diethoxyethane (DME)), linear esters (e.g., methyl formate, methyl acetate, ethyl acetate, methyl propionate, ethyl butyrate), and nitriles (e.g., acetonitrile

The amount of high boiling point solvent and low boiling point solvent present in the electrolyte may be any useful amount that is useful to realize the battery characteristics desired. Illustratively, the amount of low boiling solvent/high boiling solvent ratio by weight (solvent ratio) may be 0.1, 0.2, 0.5, 1, 1.2, or 1.5 to 20, 15, 10, 5 or 2.

The battery may have any suitable further components such as a separator and current collector and cathode.

The cathode may include any material sufficient to have desirable discharge capacity and charge retention when used with an anode and localized high concentration electrolyte. Examples of suitable cathode materials may include phosphates, fluorophosphates, fluorosulfates, fluorosilicates, spinels, lithium-rich layered oxides, and composite layered oxides. Further examples of suitable cathode materials may include spinel structure lithium metal oxides, layered structure lithium metal oxides, lithium-rich layered structured lithium metal oxides, lithium metal silicates, lithium metal phosphates, metal fluorides, metal oxides, sulfur, metal sulfides, metal fluoride, disordered rock salt structures, or any combination thereof.

The cathode may further include other cathode components such as binders and electrical conducting additives. The binder may be any suitable such as those known in the art and may include, for example, carboxy methyl cellulose (CMC), styrene-butadiene rubber (SBR), polyvinylidene fluoride (PVDF), poly-tetrafluoroethylene (PTFE), or a mixture of two or more thereof. Desirably, the cathode is comprised of PVDF. The electrically conducting additive may such as graphite, carbon black, carbon nanotubes, graphene and carbon fiber.

Examples of suitable separators may include a poly-imide, polyolefin (such as polypropylene), polyethylene terephthalate, ceramic-coated polyolefin, cellulose, or a mixture of two or more thereof. Such materials may be in the form of microfibers or nanofibers. The separator may include a combination of microfibers and nanofibers. In certain embodiments, the separator includes polyethylene terephthalate microfibers and cellulose nanofibers. Illustrations of separators that may be useful include those described in U.S. Pat. No. 8,936,878, incorporated herein by reference. Further examples of separators include those available from Dreamweaver International (Greer S.C). Typically, the separator is at most 250 micrometers thick to at least about 5 or 10 micrometers thick.

It is understood that each of these cell components may be connected or contained with other common cell components of a battery such as current collectors coated with the anode and cathode and battery containers or housings encompassing the battery components with electrical connection to the battery. For example, the current collector may be any suitable metal (e.g., Al, Alloys of Al and Cu and alloys of Cu) foil, sheet or the like such as a metal foil that may be further coated with an electrical conducting material such as carbon including those described by U.S. Pat. No. 9,172,085, incorporated herein by reference.

The lithium metal laminate anode maybe made by contacting a lithium metal foil with an addition monomer to form an uncured layer and polymerizing the addition monomer forming a thermoset polymer adhered to the lithium metal foil. The lithium metal foil is understood to mean any lithium metal (including alloys thereof) that is in the form of a sheet and may be formed by traditional metal foil forming techniques such as roll pressing or may be chemically or physically sputtered onto a metal substrate such as current collector described above.

The addition monomer may be coated upon the lithium metal by any suitable method such as those known in the art and may include casting, spraying, brushing or roll coating. Desirably, the addition monomer is dissolved in a solvent along with a salt and initiator such as those described above. The amount of solvent may be any useful to wet and coat the lithium metal foil to the desired uniformity. Illustratively, the amount of solvent may be from 10%, 20%, 30%, 40%, 50% to 99%, 95% or 90% by weight of the addition monomer, solvent and salt. The amount of salt may be any amount such as described above for the uncured layer (amount of monomer, salt and solvent). Desirably, at least a portion (e.g., 10%, 25%, 50% or 75% to essentially all) of the solvent is removed prior to polymerizing the addition monomer. The removal of the solvent may be any method that does not cause the polymerization of the addition monomer. For example, evaporation of the solvent at a temperature below where the initiator initiates (initiation temperature) the polymerization may be employed and may be room temperature (e.g., ˜25° C.) or elevated temperature that is at least 5° C., 10° C. or 20° C. below the initiation temperature. The removal may be aided by applying a vacuum (reduced gaseous pressure) and may also involve sweeping a flowing gas over the uncured layer to remove the desired amount of solvent. It is believed, without being limiting in any way, that the removal of the solvent facilitates the cross-linking and protective characteristics desired.

In another embodiment, the lithium metal laminate anode may be made by contacting a metal foil other than lithium with an addition monomer to form an uncured layer, polymerizing the addition monomer forming a layer of a thermoset polymer adhered to the metal foil to form a lithium free anode and electrochemically introducing lithium ions to the lithium free metal anode to form the lithium metal laminate anode. Illustratively, the metal may be any useful as a current collector such as copper having the thermoset layer adhered thereto. The lithium may be introduced electrochemically during the initial charging and discharging when forming the battery.

### ILLUSTRATIONS

Illustration 1. An anode, comprising a laminate comprised of a lithium metal having adhered thereto a layer comprised of a thermoset polymer.
Illustration 2. The anode of illustration 1, wherein the thermoset polymer is comprised of a thermoset addition polymer.
Illustration 3. The anode of illustrations 1 or 2, wherein the addition polymer is of a monomer comprised of an alkene, alkyne or both.
Illustration 4. The anode of any one of the previous illustrations, wherein the thermoset polymer has a carbonyl, ether, amide, imide, sulfonyl group or combination thereof.
Illustration 5. The anode of illustration 3 or 4, wherein the monomer is comprised of an addition monomer having 2 to 6 addition polymerizable groups.
Illustration 6. The anode of any one of illustrations 3 to 5, wherein the monomer is comprised of an addition monomer having 3 to 5 addition polymerizable groups.
Illustration 7. The anode of any one of the preceding illustrations wherein the layer is further comprised of a lithium salt.
Illustration 8. The anode of illustration 7, wherein the salt is present in an amount of 1% to 25% by volume in the layer.
Illustration 9. The anode of illustration 8, wherein the salt is present in an amount of 5% to 25% by volume in the layer.
Illustration 10. The anode of any one of illustrations 3 to 10, wherein the monomer is comprised of an acrylate represented by:

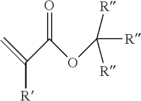

wherein R′ is hydrogen or an aliphatic group having 1 to 4 carbons and each R″ is independently a substituted or unsubstituted cyclic, linear, branched, or aromatic hydrocarbyl group having 1 to 24 carbons.
Illustration 11. The anode of any one of illustrations 3 to 10, wherein the monomer is comprised of one or more of pentaerythritol tetracrylate, trimethylolpropane trimethacrylate, trimethylolpropane propolylate triacrylate, vinyl methacrylate.
Illustration 12. The anode of either illustrations 8 or 9, wherein the lithium salt is comprised of one or more of (oxalato)borate (LiBOB), lithium bis(pentafluoroethylsulfonyl)imide (Li-BETI), lithium bis(fluorosulfonyl)imide (LiFSI), lithium tetrafluoroborate (LiBF₄), lithium trifluoromethanesulfonate (LiTriflate), lithium hexafluoroarsenate (LiAsF₆), lithium bis(trifluoromethanesulfonimide) (LiTFSI), and lithium hexafluoro-phosphate (LiPF₆), lithium nitrate (LiNO₃), LiN(SO₂CF₃)₂, LiN(SO₂F)₂, LiCF₃SO₃, LiClO₄, lithium difluoro oxalato borate anion (LiDFOB), LiI, LiBr, LiCl, LiOH, LiSO₄, or any combination thereof,
Illustration 13. The anode of any one of the preceding illustrations, wherein the layer is comprised of a plurality of sublayers that are different.
Illustration 14. The anode of any one of illustrations 1 to 12, wherein the layer has a thickness and a property varies from the lithium metal to the layer's outer surface.
Illustration 15. The anode of any one of illustrations 1 to 14, wherein the lithium metal is treated to enhance the adherence of the layer.
Illustration 16. The anode of any one of illustrations 1 to 15, wherein the layer is further comprised of an additive.
Illustration 17. The anode of illustration 16, wherein the additive is comprised of a lithium intercalation compound.
Illustration 18. The anode of illustration 17, wherein the lithium intercalation compound is of one or more of silicon, silicon alloys, graphite and lithium titanate.
Illustration 19. The anode of illustration 18, wherein the intercalation compound is comprised of graphite.
Illustration 20. A battery comprised of a liquid electrolyte comprised of a polar aprotic solvent and a dissolved lithium salt and the anode of any one of the preceding illustrations.
Illustration 21. The battery of illustration 20, wherein at least one dissolved lithium salt is chemically different than the lithium salt of the layer.
Illustration 22. The battery of illustration 21, wherein each dissolved lithium salt is chemically different than the lithium salt of the layer.
Illustration 23. The battery of any one of illustrations 20 to 22, wherein the polar aprotic solvent is comprised of at least two polar aprotic solvents.
Illustration 24. The battery of illustration 23, wherein one of the polar aprotic solvents is preferentially absorbed in the layer.
Illustration 25. The battery of illustration 24, wherein the solvent the polar aprotic solvent that is preferentially absorbed in the layer swells the layer by at least 10% to 50% more than another solvent present in the electrolyte.
Illustration 26. The battery of any one illustrations 20 to 25, wherein the swelling of the layer is at most about 10% by volume.
Illustration 27. The battery of any one of illustration 21 to 26, wherein the layer thickness 0.01 micrometer to 100 micrometers.
Illustration 28. A method of forming a lithium metal laminate anode comprising, contacting a lithium foil with an addition monomer to form an uncured layer and polymerizing the addition monomer forming a layer of a thermoset polymer adhered to the lithium metal foil.
Illustration 29. The method of illustration 28, wherein during the contacting, the addition monomer is dissolved in a solvent.
Illustration 30. The method of illustration 28, wherein at least a portion of the solvent is removed prior to polymerizing of the monomer.
Illustration 31. The method of any one of illustrations 28 to 30, wherein the addition monomer has an average addition reactive functionality of at least 2.
Illustration 32. The method of illustration 31, wherein the average addition reactive functionality is at least 2.5.
Illustration 33. The method of illustration 31, where in the average addition reactive functionality is at least 3 to 6.
Illustration 34. The method any one of illustrations 28 to 33, wherein the addition monomer is comprised of an addition polymerizable alkene or alkyne and one or more carbonyl, ether, amide, imide and sulfonyl group.
Illustration 35. The method of illustration 34, wherein the addition monomer is comprised of an acrylate having 2 to 6 vinyl groups.
Illustration 36. The method of illustration 34, wherein the acrylate is comprised or one or more of pentaerythritol tetraacrylate, trimethylolpropane trimethactylate. Trimethylolpropane propoxylate tetracrylate, trimethlolpropane ethoxylate triacrylate, ethoxylate triacrylate, poly(ethylene glycol)dimethacrylate, vinyl methacrylate, and 2,23,3-tetrafluoropropyl methacrylate.
Illustration 37. The method of any one of illustrations 28 to 36, wherein the polymerizing is performed in the presence of a catalyst.
Illustration 38. The method of illustration 37, wherein the catalyst is a radical initiator, anionic or cationic catalyst.
Illustration 39. The method of illustration 38, wherein the catalyst is a radical initiator comprising of an azo initiator.
Illustration 40. A method of forming a lithium metal laminate anode comprising, contacting a metal foil other than lithium with an addition monomer to form an uncured layer, polymerizing the addition monomer forming a layer of a thermoset polymer adhered to the metal foil to form a lithium free anode and electrochemically introducing lithium ions to the lithium free metal anode to form the lithium metal laminate anode.
Illustration 41. The method of illustration 40, wherein the metal foil is a copper.

### EXAMPLES

Example 1 is made by drop casting (70 microliters) onto a 20 micrometer thick lithium metal deposited on a copper foil (Honjo Metal Co. Ltd. Japan) a solution comprised of 1.5% pentaerythritol tetracrylate monomer and 0.1% by weight 2,2′-Azobis(isobutyronitrile) initiator in 1M LiTFSI in a 1,3-dioxolane/dimethoxyethane (½ by volume solution) having 1% by weight lithium nitrate to form an uncured layer on the lithium metal foil. The uncured layer is polymerized by allowing the solvent to evaporate in a inert atmosphere (e.g., glove box high purity argon) for 1 hour at room temperature and then heated to 80° C. under vacuum to form the laminate anode.

The laminate anode is formed into a battery cell using a NMC 622 (LiNi_{0.6}Mn_{0.2}Co_{0.2}O₂) compound formed into a cathode film. Each battery cell included the composite cathode film, a polypropylene separator, and a lithium metal anode film. Electrolyte components (1M lithium difluoro(oxalato)borate (LiDFOB) in fluorinated ethylene carbonate/propyl propionate/ethyl difluoroacetate, 1/4.5/4.5 by volume) were formulated and added to the battery cell, which was then sealed. The formation cycle for NMC 622//Li cells was 12 hours OCV (open circuit voltage) hold, followed by a C/10 charge to 4.3 V with a CV (constant voltage) hold until the charge current was terminated by reaching 0.05 C. Then the cells discharged at C/10 current to 3.0 V at 30° C. The process was repeated twice to complete the formation cycles. Cells were then cycled between 4.3 V and 3 V with 0.33 C charge and 0.33 C discharge cycling rates.

Example 2 is made in the same manner as Example 1, except that the polymerization was performed by heating directly to 80° C. and then drying under vacuum at room temperature in the glove box.

Example 3 is made in the same manner as Example 1 without any LiTFSI.

Example 4 is made in the same manner as Example 2 except the amount of lithium nitrate in the solution is 5% by weight.

Example 5 is made in the same manner as Example 1 without any Azobis(isobutyronitrile) initiator.

Comparative Example 1 is made in the same manner as Example 1, but in the absence of the layer (i.e., pristine lithium metal foil).

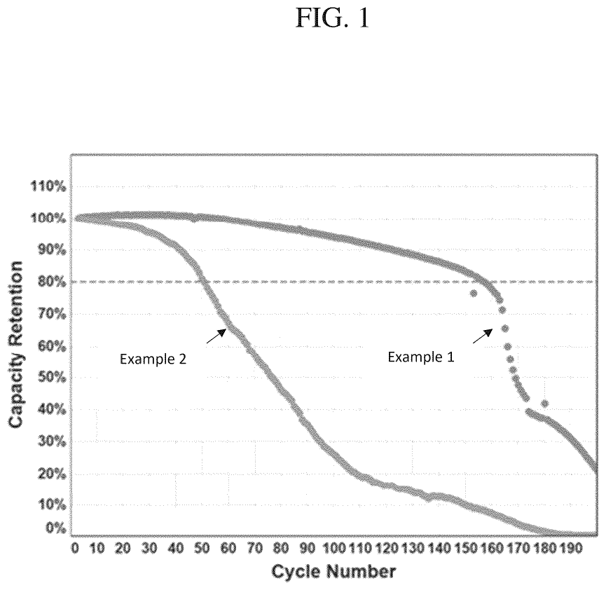

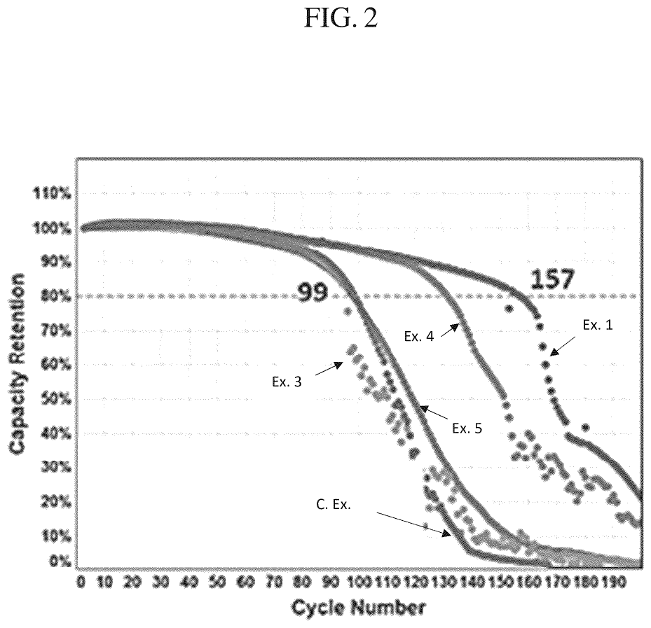

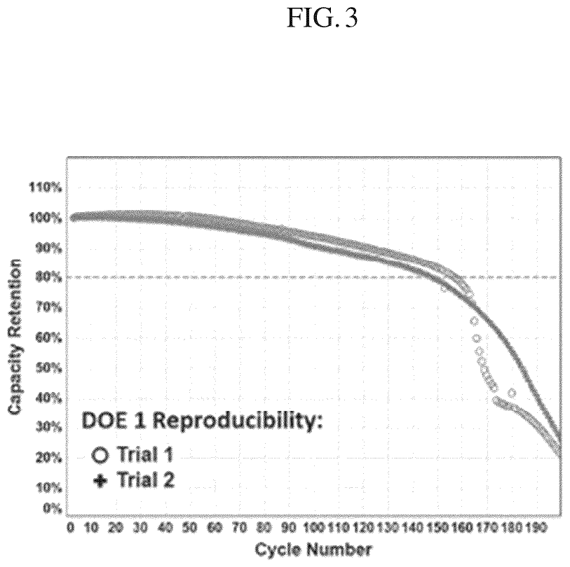

FIG. 1 compares the cycling behavior of Examples 1 and 2 showing the effect of removing the solvent prior to polymerization of the addition monomer. FIG. 2 shows each of the Examples 1, 3-5 and the Comparative Example showing that the use of sufficient amount of salts in the uncured layer substantially improves the performance of the battery cell and the necessity to initiate the addition polymerization for this particular system. It also shows that substantial improvements in the cycle life may be obtained by small amounts of salt in the layer of the anode (i.e., see Examples 1 and 4). FIG. 3 shows the reproducibility of Example 1 to improve the cycle life of the battery cell having the laminate anode of this invention.

The swelling of an illustrative layer is shown in Table 1. The swelling ratio is determined by curing a layer of 1.5% or 5% by weight TPEOTA (Shown below).

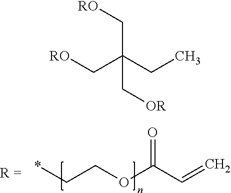

The swelling ratio is determined by weighing an empty copper substrate, dropcasting a 70 micro-liters of a precursor solution onto the copper substrate and curing the precursor solution at 80° C. for at least 12 hours. The precursor solution is the same as described for Example 1 except the use of TPEOTA and the amount thereof in the solution as shown in the Table 1. The swelling ratio is determined by the weighing the can prior to and after curing using the following equation.

$$Swelling ratio = ( {M}_{w} - {M}_{d} ) / {M}_{d}$$

The M_{d} is determined by weighing the substrate after curing the layer and removing the solvent of the precursor solution and subtracting the empty weight of the substrate. The M_{w} (wet mass) is determined after exposing the cured layer to electrolyte (same as in the examples) and pipetting the excess electrolyte from the substrate and subtracting the weight of the empty substrate. The swelling % is determined by multiplying the swelling ratio by 100. The results are shown in Table 1, where the swelling % appears to correspond to the amount of TPEOTA in the precursor solution.

TABLE 1

| Precursor | | | Dry Layer | Mass After | Wet Layer | | Average |
|---|---|---|---|---|---|---|---|
| Soln. | Empty | Mass After | Mass (g) | Soaking | Mass (g) | Swelling | Swelling |
| Comp. | Case | Curing (g) | (M_{D}) | (g) | (M_{w}) | (%) | (%) |
| 1M LiFSI + | 888.3 | 903.4 | 15.1 | 922 | 18.6 | 23% | 37% ± 24% |
| 1.5% TPEOTA + | 886.2 | 901.8 | 15.6 | 920.8 | 19 | 22% | |
| 0.1% AIBN | 887.9 | 903.5 | 15.6 | 929.2 | 25.7 | 65% | |
| 1M LiFSI + 5% | 888.4 | 902.3 | 13.9 | 938.5 | 36.2 | 160% | 111% ± 43% |
| TPEOTA + | 893.5 | 909.2 | 15.7 | 939.1 | 29.9 | 90% | |
| 0.1% AIBN | 897.4 | 915.5 | 18.1 | 948.7 | 33.2 | 83% | |

What is claimed is:

1. An anode, comprising a laminate comprised of a lithium metal having adhered thereto a layer comprised of a thermoset polymer, solvent and salt, the solvent being 50% to 99%, the salt being 10% to 40% and thermoset polymer being 1.5% to 5% by weight of the solvent, salt and thermoset polymer.

2. The anode of claim 1, wherein the thermoset polymer is comprised of a thermoset addition polymer.

3. The anode of claim 2, wherein the thermoset addition polymer is of a monomer comprised of an alkene, alkyne or both.

4. The anode of claim 3, wherein the thermoset polymer has a carbonyl, ether, amide, imide, sulfonyl group or combination thereof.

5. The anode of claim 4, wherein the monomer is comprised of an addition monomer having 2 to 6 addition polymerizable groups.

6. The anode of claim 1 wherein the layer is further comprised of a lithium salt.

7. The anode of claim 6, wherein the salt is present in an amount of 1% to 25% by volume in the layer.

8. The anode of claim 5, wherein the monomer is comprised of an acrylate represented by: 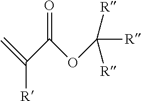
wherein R′ is hydrogen or an aliphatic group having 1 to 4 carbons and each R″ is independently a substituted or unsubstituted cyclic, linear, branched, or aromatic hydrocarbyl group having 1 to 24 carbons.

9. The anode of claim 8, wherein the monomer is comprised of one or more of pentaerythritol tetracrylate, trimethylolpropane trimethacrylate, trimethylolpropane propolylate triacrylate, vinyl methacrylate.

10. The anode of claim 6, wherein the lithium salt is comprised of one or more of (oxalato)borate (LiBOB), lithium bis(pentafluoroethylsulfonyl)imide (Li-BETI), lithium bis(fluorosulfonyl)imide (LiFSI), lithium tetrafluoroborate (LiBF4), lithium trifluoromethanesulfonate (LiTriflate), lithium hexafluoroarsenate (LiAsF6), lithium bis(trifluoromethanesulfonimide) (LiTFSI), and lithium hexafluoro-phosphate (LiPF6), lithium nitrate (LiNO3), LiN(SO2CF3)2, LiN(SO2F)2, LiCF3SO3, LiClO4, lithium difluoro oxalato borate anion (LiDFOB), LiI, LiBr, LiCl, LiOH, LiSO4, or any combination thereof.

11. The anode of claim 7, wherein the layer is further comprised of an additive.

12. The anode of claim 11, wherein the additive is comprised of a lithium intercalation compound.

13. The anode of claim 12, wherein the lithium intercalation compound is of one or more of silicon, silicon alloys, graphite and lithium titanate.

14. A battery comprised of a liquid electrolyte comprised of a polar aprotic solvent and a dissolved lithium salt and the anode of claim 1.

15. The battery of claim 14, wherein at least one dissolved lithium salt is chemically different than the lithium salt of the layer.

16. The battery of claim 15, wherein each dissolved lithium salt is chemically different than the lithium salt of the layer.

17. The battery of claim 16, wherein the polar aprotic solvent is comprised of at least two polar aprotic solvents.

18. The battery of claim 17, wherein one of the polar aprotic solvents is preferentially absorbed in the layer.

19. The battery of claim 18, wherein the polar aprotic solvent that is preferentially absorbed in the layer swells the layer by at least 10% to 50% more than another solvent present in the electrolyte.

20. (canceled)

21. (canceled)

22. (canceled)

23. (canceled)

24. (canceled)

25. (canceled)

26. (canceled)

27. (canceled)

28. (canceled)

29. (canceled)
